(19) United States
(12) Patent Application Publication
(10) Pub. No.: US 2005/0092763 A1
(43) Pub. Date: May 5, 2005

(54) Package for storing and dispensing edible film strips

(75) Inventors: Anne E. Haggerty, Belleville, NJ (US); Jeffrey S. Gibb, Boonton, NJ (US); Richard A. Hildebrandt, New Hope, PA (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/699,942

(22) Filed: Nov. 3, 2003

(51) Int. Cl. A47J 36/00

(52) U.S. Cl. 220/912

(57) ABSTRACT

A package for storing and dispensing edible film strips comprising a tray and lid that slide relative to each other between open and closed positions. The tray may include a ridge spaced from the front edge of the tray to direct film strips upward in advance of the front edge as they are pushed forward. Stops may be provided to retain the lid in a closed position and inhibit travel of the lid beyond a predetermined open position. Exterior surface structure may be provided on the tray and lid to facilitate manual engagement.

### FIELD OF THE INVENTION

The invention relates to packages for food products, particularly to packages for storage, dispensing, and retail distribution of edible film strips.

### BACKGROUND OF THE INVENTION

In recent years, edible food products have become increasingly popular. Such film strips typically dissolve in the consumer's mouth over a short period of time. The strips may be generally rectangular, with lengths and widths of between, e.g., about ½ and 1½ in., and a thickness of e.g., 1 to 5 mils., or may be of other shapes and sizes.

In providing retail food product packaging for edible film strips, among the considerations that must be addressed are the cost of manufacture, ease of assembly, and ability to be loaded with multiple strips without spillage or breakage in automated high speed commercial packaging operations. Additional considerations include the ability of the package to withstand loads experienced during use without breakage and without permitting any of the film strips to escape. The package should also provide an attractive appearance at the point of purchase.

Edible film strips are typically sold in packages small enough to be carried in a pocket or purse. The package should be easy to open and close, and capable of permitting the strips to be easily withdrawn one at a time. The package should close securely so that the strips are released only when the package is open.

Prior art patents disclosing vials or cases for films include U.S. Patents D371,723, D422,460, D423,301, and D423,302.

There is a need for improved film strip packaging.

### SUMMARY OF THE INVENTION

The invention provides an improved container for food products such as film strips. The package preferably is of two-piece construction comprising a tray provided with a ridge that protrudes upward from a bottom wall to direct film strips upward and outward as they are pushed forward for dispensing, and a lid that translates between open and closed positions in sliding contact with the tray. The lid is preferably retained in closed position by an interference fit or detent until sufficient opening force is applied. One or more stops are preferably provided to inhibit displacement of the lid beyond its predetermined open position, travel is preferably limited by one or more stops. The package may be capable of one-handed operation, such that a user may open the package, dispense a film strip, and close the package using only one hand.

One or both of the tray and lid may include a surface structure against which force may be applied for translating the tray and lid relative to each other. The surface structure may include embossed or raised surface structure, indentations, or one or more ridges. The above mentioned ridge that protrudes upward into the interior of the tray from the bottom wall of the tray to direct film strips upward and outward may be formed by deforming the bottom wall of the tray upward so as to create a complementary elongate indentation on the bottom surface of the bottom wall of the tray to facilitate application of opening and closing force.

Interference between the tray and lid may be provided by one or more indentations in the lid spaced from a lid wall and engaging a portion of the tray when the lid is in closed position so that the portion of the tray is interference-held between the wall and the indentation when the package is in a closed position.

The package is preferably made of metal. The lid preferably has a front edge defined by a fold or hem. Various surfaces of the package may be textured, roughened, pebbled or otherwise treated to decrease friction between the tray and lid, and/or to improve handling characteristics, e.g., by providing a higher coefficient of friction with the user's hands. Information such as product identification and directions for use or storage of the product or package may be provided by paint, ink, or other surface treatments which may include embossing or other three dimensional indicia.

The lid is preferably constrained for low friction linear travel relative to the tray by providing a pair of channels on the lid to receive elongated guides on the tray. The tray preferably includes a top wall and a pair of side walls depending therefrom, with a rolled rim extending along the bottom of each side wall and a longitudinal guide channel defined between the top wall and the rolled rim. The tray preferably includes a bottom wall and a pair of side walls extending upward therefrom, with a longitudinal rolled rim on the upper edge of each side wall to be received in a respective one of the guide channels on the lid.

The lid also preferably includes a rear wall having a rolled rim extending along the bottom of the rear wall. The rolled rims on the side walls and rear wall of the lid preferably comprise a continuous rolled rim. As viewed in cross section, the rolled rim is preferably rolled through and arc of about 270 degrees such that an extension of the outer surface of the side wall forms the top surface of the rolled rim and engages the bottom of the rolled rim on the tray.

To reduce the possibility of accidental spillage of film strips, the package may include a tray insert that partially covers the film strips in the tray while leaving portions adjacent their leading ends exposed to facilitate dispensing.

In one embodiment, the film strips comprise hydroxypropyl methylcellulose, flavor, maltodextrin, corn starch, hydroxypropyl cellulose, triacetin, polysorbate 80, ethyl alcohol, sucralose, titanium dioxide, and potassium acesulfame. In other embodiments, the film strips may comprise other combinations of ingredients.

### BRIEF DESCRIPTION OF THE DRAWINGS

FIG. 1 is a perspective view of a package in accordance with an embodiment of the invention in a closed position;

FIG. 2 is a perspective view of the package of FIG. 1 in an open position without embossing or indicia;

FIG. 3 is a bottom plan view of the package of FIG. 2;

FIG. 4 is a front elevation view of the package of FIG. 1;

FIG. 5 is side elevation view of the package of FIG. 1;

FIG. 6 is a perspective view of a top of the package of FIG. 1;

FIG. 7 is a perspective view of a package in accordance with a second embodiment; and

FIG. 8 is a sectional view taken along lines 8-8 in FIG. 7.

### DETAILED DESCRIPTION

The invention is preferably embodied in a package 10 for a stack 20 of film strips comprising a tray 14 comprising a bottom wall 102, a pair of side walls 104, a rear wall 106 and a front wall 108. The tray comprises a deep rear portion 110 having a generally horizontal bottom and a shallow front portion 112 joined to the rear portion 110 by a transition section 114 having a sloping bottom 116. A lid 12 translates between open and closed positions in sliding contact with the tray.

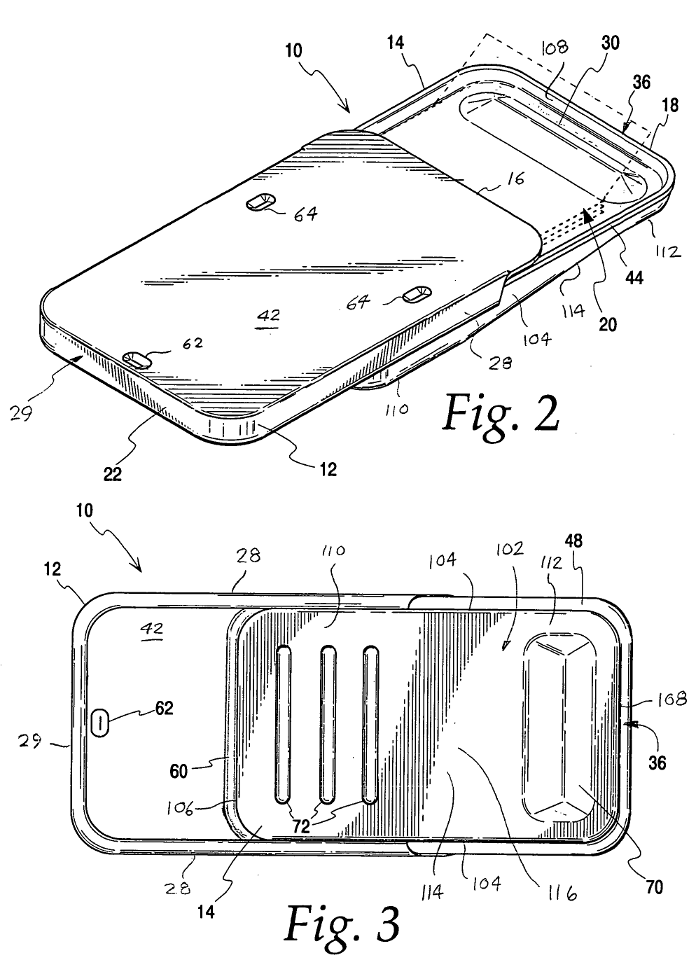

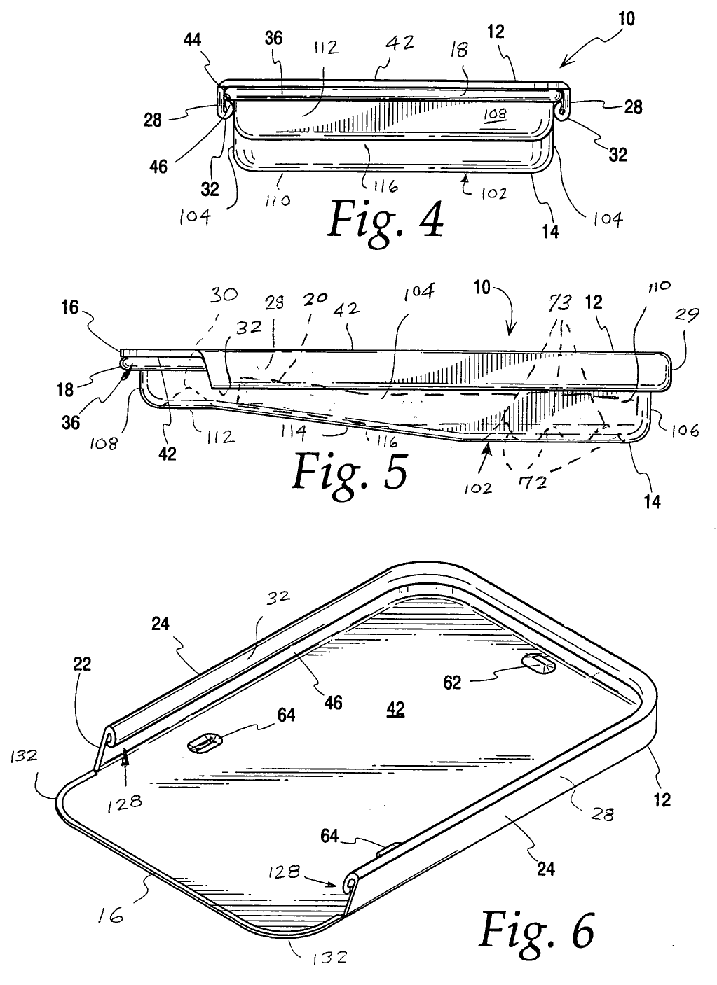

To facilitate dispensing of the film strips, a transverse ridge 30 is provided at the bottom of the shallow front portion 112 to direct film strips upward and outward as they are pushed forward. The ridge 30 is configured so that a leading edge 21 of a film strip 23 may be forced upward above the walls of the tray by forcing the film strip 23 forward toward the front wall 108 of the container against the ridge while applying downward pressure thereto when the lid 12 is in an open position as shown in FIG. 2. The ridge 30 may be formed by indenting the bottom wall of the tray upward so as to create a complementary elongate indentation 70 on the bottom surface of the bottom wall of the tray to facilitate application of opening and closing force.

The lid 12 is preferably constrained for low friction linear travel relative to the tray by providing a pair of channels 128 on the lid to receive elongated rim portions 44 of the tray 14. The lid preferably includes a top wall 42, a pair of side walls 28 and a rear wall 29. Each wall has a planar portion 22, a rolled rim 32 extending along the bottom of each wall, and a longitudinal guide channel 128 defined between the top wall and the side wall rolled rims. The tray preferably includes a longitudinal rolled rim 36 on the upper edges of the walls to be received in a respective one of the guide channels 128 on the lid. The tray also has front and rear rolled rim portions 18 and 60 respectively.

The rolled rim 32 on the side walls and rear wall of the lid preferably comprises a continuous rolled rim. As viewed in cross section, the rolled rim is preferably rolled through an arc of between 180 and 360 degrees, specifically about 270 degrees, such that an extension of the outer surface of the side wall 28 forms the curved top surface of the rolled rim and engages the curved bottom of the rolled rim on the tray. The inner surface 46 of each side wall 28 of the lid 12 above the rim 32 is substantially planar in the illustrated embodiment, and engages a curved surface of an adjacent tray rim portion 44.

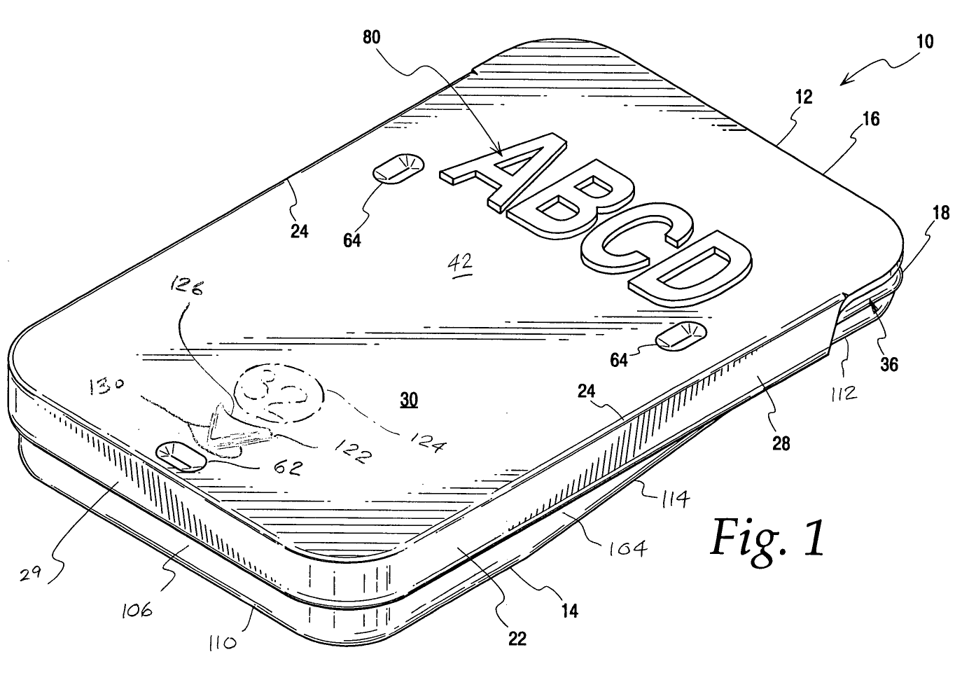

The lid 12 is preferably retained in closed position as shown in FIG. 1 by a detent comprising a deformation 62 on the lid engaging a rear portion 60 of a rolled rim 36 on the tray. When sufficient opening force is applied, the deformation 62 and/or the rim portion 60 are elastically deformed enough to permit the lid to open. While a single detent is shown in the illustrated embodiment, a plurality of detents may be provided in other embodiments.

One or more stops 64 are preferably provided to engage the rim portion 60 when the lid reaches its fully open position and thereby inhibit displacement of the lid beyond its predetermined open position. The lid is preferably capable of linear travel past its predetermined open position only upon application of a force substantially greater than the force required to open the container. To this end, the stops 64 may be similar or identical in size and shape to the deformations 62, but greater in number. The deformations 62 and stops 64 are preferably small protrusions formed by indenting the top wall of the lid. The magnitude of the protrusions may be between 0.01 and 0.03 in.

The tray 14 and lid 12 may be made of a metal and may comprise, e.g., steel, tin, or aluminum. The thickness of the metal may be, e.g., between 0.005 and 0.03 in., and in one particular embodiment is about 0.01 in., or between 0.005 and 0.015 in. In some embodiments, the tray and lid may be stamped from sheet stock and formed using single step or multi-step stamping, rolling and/or other metal forming operations by computer controlled machines in high speed commercial mass production. The tray is may be filled with film strips by apparatus that advances the tray on a conveyor to a film strip receiving station, then fills each tray with a predetermined number of strips, then advances the tray to a lid application station at which the longitudinal channels 128 of the lid are placed in engagement with the side portion 44 of the rim of the tray and the lid is pushed forward on the tray, deflecting the stops upward by flexure of the top wall of the lid as the stops pass over the rear portion of the tray rim, then snapping the lid into closed position. In some embodiments, assembly and filling may be performed entirely by electronically controlled apparatus. In other embodiments, forming, filling and assembly of the container may be performed partially or entirely by hand.

The container 10 may be capable of one-handed operation, such that a user may hold the container, open it, dispense a single film strip, and close the container using only one hand. To this end, the force required to open the container preferably is sufficiently low that it may be applied using only a thumb and finger. In some embodiments, the lid 12 may have means to facilitate application of opening force on the forward half of the lid and specifically near its forward end 16, so that downward pressure need not be applied near the detent, in view of the fact that downward force in that region might make opening more difficult by increasing the force required for opening. The means to facilitate application of opening force near the front of the lid may comprise, e.g., embossed designs, ridges, ribs, indentations, protrusions, surface roughening, high friction coatings and the like. In some embodiments, one or more indicia such as product identifiers, product names, trademarks, other graphics or the like having particular shapes may be printed or painted on raised or embossed surfaces providing the dual function of prominently displaying the indicia while facilitating opening and closing of the lid by facilitating engagement by the user's hand. In the illustrated embodiment, the lid has raised lettering 80 (FIG. 1) on its front half, and on its rear half has a raised, generally triangular arrow 122 comprising a convergent pair of linear edges 130 and a concave edge 126, and pointing in an opening direction. Indicia 124 adjacent the rear edge 126 of the arrow may comprise, e.g., a numeral indicating the number of strips in the container, displayed in a circle concentric with the center of curvature of the rear edge of the arrow as shown. The raised lettering and arrow engage the user's finger to facilitate both opening and closing. The force required to snap the lid into closed position preferably has about the same magnitude as the opening force.

Concave indentations or groves 72 may be formed in the bottom wall 102 of the tray to facilitate application of manual opening and closing force at the deep rear portion 110. Corresponding raised ribs 73 on the interior of the bottom wall support the stack 20 of strips and may reduce heat transfer through the bottom wall.

To improve the feel of the container by decreasing potential stress concentrations on the fingers of a user during handling of the container, the lid preferably has a front edge 16 defined by a fold or hem, as shown in FIG. 6. The illustrated front edge is linear over most of its length, with curved transition regions 132 where it meets the side edges of the lid. The illustrated hem extends along both the linear region and the curved transition regions, and is formed without perceptible wrinkles, providing the front end of the lid with a double thickness rounded edge having a smooth look and feel and a thickness of between 0.02 and 0.03 in.

Various surfaces of the package may be coated, polished, textured, roughened, pebbled or otherwise treated to decrease friction between the tray and lid, and/or to improve handling characteristics, e.g., by providing a higher coefficient of friction with the user's hands. Information such as product identification and directions for use or storage of the product or package may be provided by paint, ink, or other surface treatments which may include embossing or other three dimensional indicia.

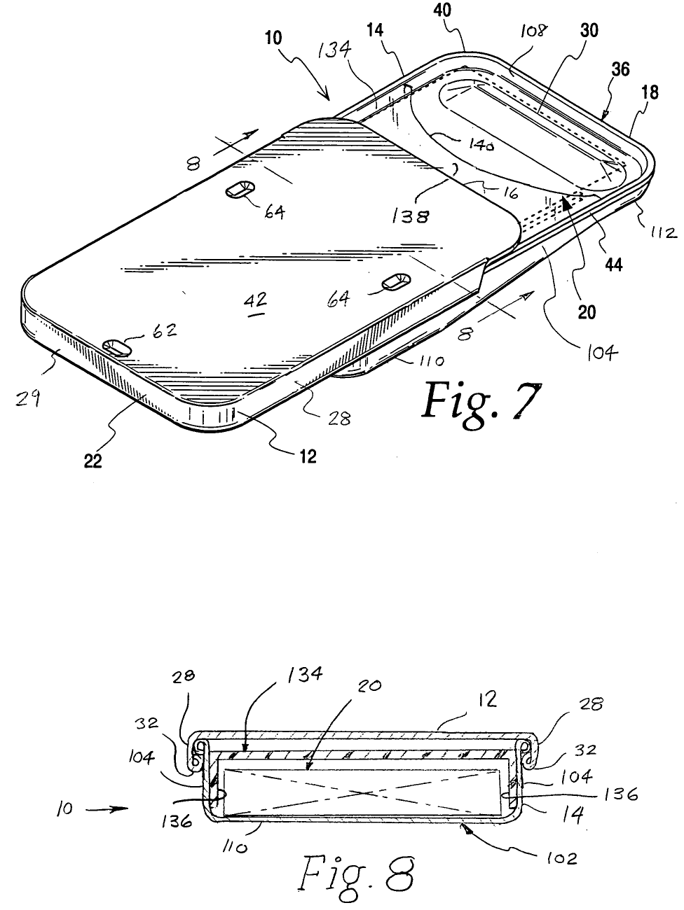

To reduce the possibility of accidental spillage of film strips, the package may include a tray insert 134 that partially covers the film strips in the tray while leaving their leading ends exposed to facilitate dispensing, as shown in FIGS. 7 and 8. The illustrated insert 134 comprises a pair of side walls 136 connected by a top wall 138. The insert is configured to fit within the container when compressed slightly, and is sufficiently stiff and resilient to retain itself in place within the container when pressed into the position shown in FIG. 8. The forward edge 140 of the insert is curved inward from the sides to provide a slot for a user's thumb or finger.

In some embodiments, the film strips comprise hydroxypropyl methylcellulose, flavor, maltodextrin, corn starch, hydroxypropyl cellulose, triacetin, polysorbate 80, ethyl alcohol, sucralose, titanium dioxide, and potassium acesulfame. In other embodiments, the film strips may comprise other combinations of ingredients.

The container may be loaded with any desired number of film strips, e.g., 16, 24, 32 or more.

The film strips may be dimensioned so that the forward edge of each strip is positioned rearward of the ridge 30 as shown in FIG. 2 prior to dispensing, with the rear edge of each strip abutting the rear wall of the tray. To this end, the film strips may be shorter than the interior of the tray by at least the width of the ridge. In one embodiment, the container 10 has a length of between 1.5 in. and 2 in., a width between 1 in. and 1.5 in, at its deep end, and a depth of between 0.125 in. and 0.25 in. at its shallow end, with the ridge protruding 0.05 to 0.2 in. upward. In this embodiment, each film strip has a length of 1 in. to 1¼ in. and a width between ¾ in. and 1 in., and is shorter than the interior of the tray by between ¼ in. and ½ in. In this embodiment, each strip is narrower than the interior of the tray by 1/16 in. to 3/16 in. In other embodiments, the container and film strips may be larger or smaller with similar or difference proportions.

The filled container described above may be sealed within a larger container for retail display and sale. The larger container may comprise, e.g., a molded, three dimensional transparent front wall sealed to a paper backing or a paperboard back card having product information and the like printed thereon. The front wall may have a molded compartment for receiving the container 10.

While the accompanying drawings and the description above relate primarily to a container used in conjunction with film strips, the container may be used with other products, particularly other food products that consumers may carry in a pocket or purse such as breath mints, candy and the like. The invention is not limited to the embodiments described above. The invention is further described by the claims set forth below.

1. A film strip product comprising:
a container comprising a tray having a front, a rear, a bottom wall and at least one side wall;
a lid slidably translatable relative to said tray between open and closed positions; and
a plurality of edible film strips contained within said container;
said bottom wall having a transverse ridge configured so that a leading edge of a film strip may be forced upward above said at least one side wall by forcing said film strip forward toward the front of the container against the ridge while applying downward pressure thereto when said lid is in an open position.

2. A film strip product in accordance with claim 1 wherein said tray comprises a front wall, a rear wall and a pair of side walls, and wherein said ridge is adjacent to said front wall and spaced therefrom.

3. A film strip product in accordance with claim 2 wherein said bottom wall includes an indentation on its lower surface.

4. A film strip product in accordance with claim 3 wherein said ridge comprises an upwardly sloping ramp surface and a downwardly sloping back surface, and wherein said film strips are dimensioned to fit in said tray without overlying said ridge.

5. A film strip product in accordance with claim 1 wherein said ridge comprises an indentation in the exterior of said bottom wall and a corresponding convexity on the interior thereof, and wherein said indentation is manually engageable to facilitate application of longitudinal force to said tray to facilitate opening and closing, and wherein a user may hold the container, open it, dispense a single film strip without dispensing or spilling additional film strips, and close the container, all using only one hand.

6. A film strip product in accordance with claim 5 further comprising a detent for releasably retaining said tray and lid in closed position, and one or more stops to define a fully opened position for said lid and inhibit displacement of said lid beyond said fully opened position.

7. A film strip product in accordance with claim 6 wherein release of said lid from closed position requires application of a first force, and wherein said lid is capable of linear travel past said fully open position without damage to said container only upon application of a second force greater than said first force, and wherein said detent and said stop comprise small protrusions on a lower surface of the lid.

8. A film strip product in accordance with claim 7 wherein said tray comprises a deep rear portion, a shallow front portion, and a sloped transition portion therebetween.

9. A film strip product in accordance with claim 8 wherein said ridge adjoins said sloped transition portion.

10. A film strip product in accordance with claim 9 wherein said has a plurality of parallel elongate transverse indentations formed in its bottom surface at said deep rear portion to provide concave regions for manual engagement to facilitate opening and closing, and corresponding convex interior ribs supporting said film strips.

11. A film strip product in accordance with claim 10 wherein said tray and lid are made of a metal comprising steel, tin or aluminum.

12. A film strip product in accordance with claim 11 further comprising a manually engageable direction-indicating protrusion on said lid performing a dual function of indicating an appropriate direction of movement of the lid relative to the tray for opening thereof and facilitating application of longitudinal manual force to said lid.

13. A film strip product in accordance with claim 12 wherein said direction-indicating protrusion is generally triangular in shape, and wherein additional dual function manually engageable indicia are embossed and printed on said lid.

14. A film strip product in accordance with claim 13 wherein said tray and said lid each have longitudinal rolled rim portions, with the longitudinal rolled rim portions of said lid being beneath those of said tray, and with the respective rolled rim portions of said lid and tray having adjacent convex generally cylindrical surfaces with substantially parallel axes and being rolled through arcs of between 180 and 360 degrees.

15. A film strip product in accordance with claim 14 wherein said film strips have a lower coefficient of friction with each other than with a consumer's digit.

16. A film strip product in accordance with claim 15 wherein the lid has a hemmed front edge.

17. A film strip product in accordance with claim 16 wherein said tray and lid have low friction surface treatments to facilitate sliding of said lid relative to said tray.

18. A film strip product in accordance with claim 17 further comprising a tray insert that constrains the film strips within the tray to prevent accidental spillage while leaving portions exposed for manual engagement during dispensing.

19. A food product container comprising:
a tray having a front, a rear, a bottom wall and at least one side wall; and
a lid slidably translatable relative to said tray between open and closed positions;
said bottom wall having an interior transverse ridge adjacent to said front wall and spaced therefrom, and a corresponding exterior indentation;
said tray comprising a deep rear portion, a shallow front portion, and a sloped transition portion therebetween;
said bottom wall being sloped in said transition portion.

20. A container in accordance with claim 19 wherein said ridge adjoins said sloped transition portion, further comprising a plurality of film strips stacked in the container to the rear of said ridge and supported at least partially on a plurality of ribs in said bottom wall.
